(19) United States
(12) Patent Application Publication
(10) Pub. No.: US 2025/0371755 A1
(43) Pub. Date: Dec. 4, 2025

(54) MOTION CONVERSION DEVICE BASED ON STYLE AND METHOD FOR CONTROLLING SAME

(71) Applicant: Hyeongjae HWANG, Seongnam-si (KR)

(72) Inventor: Hyeongjae HWANG, Seongnam-si (KR)

(73) Assignee: AILIVE INC., Seongnam-si (KR)

(21) Appl. No.: 19/191,111

(22) Filed: Apr. 28, 2025

Related U.S. Application Data
(63) Continuation of application No. PCT/KR2024/012911, filed on Aug. 28, 2024.

(30) Foreign Application Priority Data
Jun. 4, 2024 (KR) 10-2024-0072963

(51) Int. Cl. G06T 11/00; G06F 16/583

(52) U.S. Cl. CPC G06T 11/001; G06F 16/5846

(57) ABSTRACT

Disclosed is a motion conversion device based on style and a method thereof, the device may extract a content feature from content motion data including a motion of an object using a content feature extraction model, extract a style feature from style information using a style feature extraction model, and generate a style motion reflecting the content feature and the style feature using a style generation model.

### CROSS-REFERENCE TO RELATED APPLICATIONS

The present application is a continuation of International Patent Application No. PCT/KR2024/012911, filed on Aug. 28, 2024, which is based upon and claims the benefit of priority to Korean Patent Application No. 10-2024-0072963 filed on Jun. 4, 2024. The disclosures of the above-listed applications are hereby incorporated by reference herein in their entirety.

### BACKGROUND

### 1. Technical Field

The present disclosure relates to a motion conversion device based on style.

### 2. Description of Related Art

With the development of generative artificial intelligence, the technology for creating text or two-dimensional images has become popular and is expanding into the area of creating three-dimensional objects.

However, the technology for creating three-dimensional objects or movements itself is still at an insufficient level, and various technologies are being studied for this purpose.

Particularly, three-dimensional objects and movements are essential elements for realistic character animation in the film and game industries, but there is a problem that it is very difficult to obtain various styles of human movements using motion capture alone.

### SUMMARY

The embodiment disclosed in the present disclosure is to provide a motion conversion device based on style.

In addition, the embodiment disclosed in the present disclosure is to provide a motion conversion device based on style capable of extracting a content feature from a content motion and a style feature from style information, and then generating a style motion based on the content feature by reflecting the style feature.

In addition, the embodiment disclosed in the present disclosure is to provide a motion conversion device based on style capable of extracting a style feature using a large-scale language model and a VLP model.

Technical problems of the inventive concept are not limited to the technical problems mentioned above, and other technical problems not mentioned will be clearly understood by those skilled in the art from the following description.

In an aspect of the present disclosure, an electronic device may include a memory configured to store at least one process for generating style motion; and a processor configured to perform an operation related to the at least one process, wherein the processor is configured to: extract a content feature from content motion data including a motion of an object using a first model for extracting the content feature, extract a style feature from style information using a second model for extracting the style feature, and generate a style motion reflecting the content feature and the style feature using a third model for generating a style, wherein the style information includes at least one of a text, a voice, an image, or a motion, and obtain the style feature from the text and the image included in the style information using a VLP (Vision-Language Pre-training) model.

In this case, the processor may be configured to convert a first text of a predetermined length or longer in the text into at least one second text in the form of word expressing character and emotion of the object included in the first text using a large-scale language model (LLM), and input the at least one second text into the VLP model, and obtain the style feature as an output value of the VLP model.

Furthermore, the processor may be configured to, based on the style information being for a character in a game, input data including a background description of the character together with the VLP model.

Furthermore, the processor may be configured to obtain a style distribution for a feature space based on a text included in the style information using the VLP model, and obtain the style feature by sampling a style vector from the obtained style distribution.

Furthermore, the processor may be configured to input a first style feature obtained from the text and the image included in the style information, a second style feature obtained from the voice included in the style information, and a third style feature obtained from the motion included in the style information into a linear layer, respectively, and control vector sizes of the first style feature, the second style feature, and the third style feature to be the same, and train the second model by reducing vector distances of the first style feature, the second style feature, and the third style feature.

Furthermore, the processor may be configured to extract a first content feature from first content motion data including a first motion of a first object, extract a second content feature from second content motion data including a second motion of a second object, extract a first style feature from first style information of the first object, extract a second style feature from second style information of the second object, generate a first style motion based on the first content feature and the first style feature, generate a second style motion based on the second content feature and the second style feature, train the first model and the third model by reducing a vector distance between the first content motion data and the first style motion, and train the first model and the third model by reducing a vector distance between the second content motion data and the second style motion. In this case, the processor may be configured to generate a third style motion based on the second content feature and the first style feature, extract a third style feature from the third style motion, extract a third content feature from the third style motion, generate a fourth style motion based on the first content feature and the third style feature, generate a fifth style motion based on the third content feature and the second style feature, train the first model and the third model by reducing a vector distance between the first content motion data and the fourth style motion, and train the first model and the third model by reducing a vector distance between the second content motion data and the fifth style motion.

Furthermore, the processor may be configured to use an encoder model when extracting the content feature, generate the style motion so that the extracted style feature is applied while removing a remaining style in the content feature using AdaIN technology, and perform at least one up-sampling on the extracted content feature reduced in size by using the encoder model, and apply the extracted style feature.

In another aspect of the present disclosure, a motion generation method based on style performed by a processor of an electronic device may include extracting a content feature from content motion data including a motion of an object using a first model for extracting the content feature; extracting a style feature from style information using a second model for extracting the style feature; generating a style motion reflecting the content feature and the style feature using a third model for generating a style, wherein the style information includes at least one of a text, a voice, an image, or a motion; and obtaining the style feature from the text and the image included in the style information using a VLP (Vision-Language Pre-training) model.

In addition, a computer program stored in a computer-readable recording medium for implementing the present disclosure may be further provided.

In addition, a computer-readable recording medium recording a computer program for implementing the present disclosure may be further provided.

### BRIEF DESCRIPTION OF THE FIGURES

FIG. 1 is a schematic diagram of a motion conversion system 10 based on style according to an embodiment of the present disclosure.

FIG. 2 is a block diagram of a motion conversion device based on style according to an embodiment of the present disclosure.

FIG. 3 is a flowchart of a motion conversion method based on style according to an embodiment of the present disclosure.

FIG. 4 is a diagram illustrating a process for extracting a style feature from style information.

FIG. 5 is a diagram illustrating a use of an encoder model as a motion feature extraction model and a style feature extraction model of 3D motion.

FIG. 6 is a diagram illustrating a measurement of a vector distance between each extracted style feature in FIG. 4.

FIG. 7 is a diagram illustrating generating a content motion with style added by repeatedly performing Convolution, AdaIN, and Up-sampling.

FIG. 8 is a diagram illustrating a method of learning an artificial intelligence model used in the motion conversion device based on style according to an embodiment of the present disclosure.

### DETAILED DESCRIPTION

In the drawings, the same reference numeral refers to the same element. This disclosure does not describe all elements of embodiments, and general contents in the technical field to which the present disclosure belongs or repeated contents of the embodiments will be omitted. The terms, such as “unit, module, member, and block” may be embodied as hardware or software, and a plurality of “units, modules, members, and blocks” may be implemented as one element, or a unit, a module, a member, or a block may include a plurality of elements.

Throughout this specification, when a part is referred to as being “connected” to another part, this includes “direct connection” and “indirect connection”, and the indirect connection may include connection via a wireless communication network.

Furthermore, when a certain part “includes” a certain element, other elements are not excluded unless explicitly described otherwise, and other elements may in fact be included.

In the entire specification of the present disclosure, when any member is located “on” another member, this includes a case in which still another member is present between both members as well as a case in which one member is in contact with another member.

The terms “first,” “second,” and the like are just to distinguish an element from any other element, and elements are not limited by the terms.

The singular form of the elements may be understood into the plural form unless otherwise specifically stated in the context.

Identification codes in each operation are used not for describing the order of the operations but for convenience of description, and the operations may be implemented differently from the order described unless there is a specific order explicitly described in the context.

The operating principle and embodiments of the present disclosure are described below with reference to the attached drawings.

In this specification, the term ‘device according to the present disclosure’ includes all of various devices that can perform computational processing and provide results to the user. For example, the device may include all of a computer, a server device, and a portable terminal, or may be in the form of one of them.

Here, the computer may include, for example, a notebook, a desktop, a laptop, a tablet PC, a slate PC, and the like mounted with a web browser.

The server device is a server that communicates with an external device to process information, and may include an application server, a computing server, a database server, a file server, a mail server, a proxy server, and a web server.

A portable terminal is a wireless communication device that ensures portability and mobility, and may include all kinds of handheld-based wireless communication devices such as PCS (Personal Communication System), GSM (Global System for Mobile communications), PDC (Personal Digital Cellular), PHS (Personal Handyphone System), PDA (Personal Digital Assistant), IMT (International Mobile Telecommunication)-2000, CDMA (Code Division Multiple Access)-2000, W-CDMA (W-Code Division Multiple Access), WiBro (Wireless Broadband Internet) terminal, a smart phone, and the like, and a wearable device such as at least one of a watch, a ring, bracelets, anklets, a necklace, glasses, contact lenses, or a head-mounted device (HMD).

The function related to artificial intelligence according to the present disclosure operates through a processor and a memory. The processor may be composed of one or more processors. At this time, the one or more processors may be a general-purpose processor such as a CPU, an AP, a DSP (Digital Signal Processor), a graphics-only processor such as a GPU, a VPU (Vision Processing Unit), or an artificial intelligence-only processor such as an NPU. The one or more processors control input data to be processed according to a predefined operation rule or artificial intelligence model stored in the memory. Alternatively, in the case that the one or more processors are artificial intelligence-only processors, the artificial intelligence-only processor may be designed as a hardware structure specialized for processing a specific artificial intelligence model.

The predefined operation rule or artificial intelligence model may be created through learning. Here, being created through learning means that a basic artificial intelligence model is learned by using a plurality of learning data by a learning algorithm, thereby creating a predefined operation rule or artificial intelligence model set to perform a desired feature (or, purpose). Such learning may be performed on the device itself in which the artificial intelligence according to the present disclosure is performed, or may be performed through a separate server and/or system. Examples of learning algorithms include supervised learning, unsupervised learning, semi-supervised learning, or reinforcement learning, but are not limited to the examples described above.

The artificial intelligence model may include a plurality of neural network layers. Each of the plurality of neural network layers has a plurality of weights, and performs neural network operations through operations between the operation results of the previous layer and the plurality of weights. The plurality of weights of the plurality of neural network layers may be optimized by the learning results of the artificial intelligence model. For example, the plurality of weights may be updated so that the loss value or cost value acquired by the artificial intelligence model is reduced or minimized during the learning process. The artificial neural network may include a deep neural network (DNN), for example, a convolutional neural network (CNN), a deep neural network (DNN), a recurrent neural network (RNN), a restricted Boltzmann machine (RBM), a deep belief network (DBN), a bidirectional recurrent deep neural network (BRDNN), or a deep Q-network, but is not limited to the examples described above.

According to an exemplary embodiment of the present disclosure, the processor may implement artificial intelligence. Artificial intelligence refers to a machine learning method based on an artificial neural network that imitates human neurons (biological neurons) to enable a machine to learn. The artificial intelligence methodology may be divided into supervised learning in which input data and output data are provided together as training data according to a learning method so that the answer (output data) to a problem (input data) is determined, unsupervised learning in which only input data is provided without output data so that the answer (output data) to a problem (input data) is not determined, and reinforcement learning in which a reward is given from an external environment whenever an action is taken in a current state (State), and learning is performed in a direction to maximize this reward. In addition, the methodology of artificial intelligence can be classified according to the architecture, which is the structure of the learning model. The architecture of widely used deep learning technology can be classified into convolutional neural network (CNN), recurrent neural network (RNN), transformer, and generative adversarial network (GAN).

The present device and system may include an artificial intelligence model. The artificial intelligence model may be one artificial intelligence model or may be implemented as multiple artificial intelligence models. The artificial intelligence model may be composed of a neural network (or artificial neural network) and may include a statistical learning algorithm that mimics the neurons of biology in machine learning and cognitive science. A neural network may mean an overall model that has problem-solving capabilities by changing the strength of the synapse connection through learning by forming a network with artificial neurons (nodes) that combine synapses. The neurons of the neural network may include a combination of weights or biases. The neural network may include one or more layers composed of one or more neurons or nodes. For example, the device may include an input layer, a hidden layer, and an output layer. The neural network constituting the device can infer a desired result (output) from an arbitrary input (input) by changing the weights of neurons through learning.

The processor may generate a neural network, train (or learn) a neural network, perform a calculation based on received input data, generate an information signal based on the result of the calculation, or retrain the neural network. The models of the neural network may include various types of models such as CNN (Convolution Neural Network) such as GoogleNet, AlexNet, VGG Network, R-CNN (Region with Convolution Neural Network), RPN (Region Proposal Network), RNN (Recurrent Neural Network), S-DNN (Stacking-based deep Neural Network), S-SDNN (State-Space Dynamic Neural Network), Deconvolution Network, DBN (Deep Belief Network), RBM (Restricted Boltzman Machine), Fully Convolutional Network, LSTM (Long Short-Term Memory) Network, Classification Network, and the like, but are not limited thereto. The processor may include one or more processors for performing calculations according to the models of the neural network. For example, a neural network may include a deep neural network.

The neural network may include CNN (Convolutional Neural Network), RNN (Recurrent Neural Network), percept, multilayer perceptron, FF (Feed Forward), RBF (Radial Basis Network), DFF (Deep Feed Forward), LSTM (Long Short Term Memory), Gated Recurrent Unit (GRU), Auto Encoder (AE), Variational Auto Encoder (VAE), Denoising Auto Encoder (DAE), Sparse Auto Encoder (SAE), Markov Chain (MC), Hopfield Network (HN), Boltzmann Machine (BM), Restricted Boltzmann Machine (RBM), Depp Belief Network (DBN), Deep Convolutional Network (DCN), Deconvolutional Network (DN), Deep Convolutional Inverse Graphics Network (DCIGN), Generative Adversarial Network (GAN), Liquid State Machine (LSM), Extreme Learning Machine (ELM), Echo State Network (ESN), Deep Residual Network (DRN), Differentiable Neural Computer (DNC), Neural Turning Machine (NTM), Capsule Network (CN), Kohonen Network (KN), and Attention Network (AN), but not limited thereto, and it will be understood by those skilled in the art that any neural network may be included.

According to an exemplary embodiment of the present disclosure, the processor may use various artificial intelligence structures and algorithms such as CNN (Convolution Neural Network), R-CNN (Region with Convolution Neural Network), RPN (Region Proposal Network), RNN (Recurrent Neural Network), S-DNN (Stacking-based deep Neural Network), S-SDNN (State-Space Dynamic Neural Network), Deconvolution Network, DBN (Deep Belief Network), RBM (Restricted Boltzmann Machine), Fully Convolutional Network, LSTM (Long Short-Term Memory) Network, Classification Network, Generative Modeling, eXplainable AI, Continual AI, Representation Learning, and AI for Material Design such as GoogleNet, AlexNet, VGG Network, BERT, SP-BERT, MRC/QA, Text Analysis, Dialog System, GPT-3, and GPT-4 for natural language processing, Visual Analytics, Visual Understanding, Video Synthesis for vision processing, Anomaly Detection, Prediction, Time-Series Forecasting, Optimization, and Recommendation for algorithms ResNet for data intelligence, but not limited thereto. Hereinafter, the embodiment of the present disclosure will be described in detail.

FIG. 1 is a schematic diagram of a motion conversion system 10 based on style according to an embodiment of the present disclosure.

Referring to FIG. 1, the motion conversion system 10 based on style according to an embodiment of the present disclosure generates a style motion by performing the following process.

The motion conversion device inputs content motion data into a first model 131 that extracts a content feature to extract the content feature.

The motion conversion device input style information into a second model 132 that extracts a style feature to extract the style feature.

The motion conversion device inputs the content feature and the style feature into a third model 133 that generates a style to extract a style motion.

The motion conversion system 10 based on style according to an embodiment of the present disclosure may generate the style motion based on the content feature and the style feature by performing the above process.

Below, a detailed embodiment in which each process is performed is described with reference to other drawings.

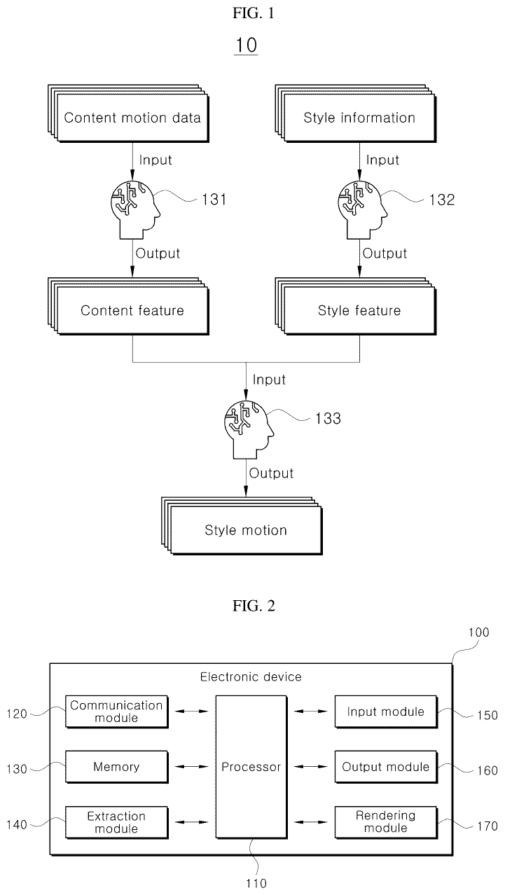

FIG. 2 is a block diagram of a motion conversion device based on style according to an embodiment of the present disclosure.

Referring to FIG. 2, an electronic device 100 for converting motion based on style according to an embodiment of the present disclosure includes a processor 110, a communication module 120, a memory 130, an extraction module 140, an input module 150, an output module 160, and a rendering module 170.

However, in some embodiments, the electronic device 100 may include fewer or more components than the components illustrated in FIG. 2.

The electronic device 100 according to an embodiment of the present disclosure may be configured to include a server device and may operate as a style-based motion conversion server.

The processor 110 may be implemented as a storage module storing data for an algorithm for controlling the operation of components within the device or a program that reproduces the algorithm, and at least one processor that performs the above-described operation using the data stored in the storage module. At this time, the storage module and the processor 110 may be implemented as separate chips. Alternatively, the storage module and the processor 110 may be implemented as a single chip.

In addition, the processor 110 may control one or more of the components discussed above in combination to implement various embodiments of the present disclosure described in the diagrams below on the device.

In addition to the operation related to the application program, the processor 110 may typically control the overall operation of the device. The processor 110 may process signals, data, information, and the like input or output through the components discussed above, or may operate an application program stored in the storage module, thereby providing or processing appropriate information or functions to the user.

In addition, the processor 110 may control at least some of the components of the device in order to operate the application program stored in the storage module. In addition, the processor 110 may operate at least two or more of the components included in the device in combination to drive the application program.

The processor 110 may be implemented as one or more. Hereinafter, even in the case that the processor is expressed as a singular number, it may be considered as plural. The processor 110 may control the configurations of the electronic device 100. The processor 110 may mean a data processing device built into hardware that has a physically structured circuit to perform a function expressed by a code or command included in a program. As such, the processor 110 may encompass processing devices such as a microprocessor, a central processing unit (CPU), a processor core, a multiprocessor, an application-specific integrated circuit (ASIC), and a field programmable gate array (FPGA), as an example of a data processing device built into hardware, but the scope of the present invention is not limited thereto. The processor 110 may separately have a learning processor 110 for performing artificial intelligence operations, or may have a learning processor 110 on its own.

In various embodiments, the processor 110 may include one or more of a central processing unit (CPU), an application processor (AP), or a communication processor (CP). At least a portion of the processor 110 may be hardware, access memory, and perform functions related to instructions stored in the memory.

The communication module 120 may include one or more modules that connect the electronic device 100 to one or more networks.

The communication module 120 may include one or more components that enable communication with an external device, and may include, for example, at least one of a broadcast reception module, a wired communication module, a wireless communication module, a short-range communication module, or a location information module.

The wired communication module may include various wired communication modules such as a Local Area Network (LAN) module, a Wide Area Network (WAN) module, or a Value Added Network (VAN) module, as well as various cable communication modules such as a Universal Serial Bus (USB), a High Definition Multimedia Interface (HDMI), a Digital Visual Interface (DVI), RS-232 (recommended standard232), power line communication, or plain old telephone service (POTS).

The wireless communication module may include a wireless communication module that supports various wireless communication methods such as a WiFi module, a WiBro (Wireless broadband) module, GSM (Global System for Mobile Communication), CDMA (Code Division Multiple Access), WCDMA (Wideband Code Division Multiple Access), UMTS (Universal Mobile Telecommunications System), TDMA (Time Division Multiple Access), LTE (Long Term Evolution), 4G, 5G, and 6G.

The wireless communication module may include a wireless communication interface that includes an antenna and a transmitter that transmits a communication signal. In addition, the wireless communication module may further include a signal conversion module that modulates a digital control signal output from the processor 110 through the wireless communication interface into an analog wireless signal under the control of the processor 110.

The short-range communication module is for short-range communication, and may support short-range communication by using at least one of Bluetooth, RFID (Radio Frequency Identification), Infrared Data Association (IrDA), UWB (Ultra-Wideband), ZigBee, NFC (Near Field Communication), Wi-Fi (Wireless-Fidelity), Wi-Fi Direct, or Wireless USB (Wireless Universal Serial Bus) technology.

The communication module 120 may also use the term of a communication interface.

The communication interface may establish communication between the electronic device 100 and an external device. For example, the communication interface can communicate with the external device through wireless communication (e.g., Wi-Fi (Wireless Fidelity), Bluetooth, NFC (Near Field Communication), MST (magnetic stripe transmission), etc.) or wired communication.

The memory 130 may store data supporting various functions of the device. The memory 130 may store a plurality of application programs (or applications) driven by the device, data for the operation of the device, and commands. At least some of these application programs may exist for the basic functions of the device. Meanwhile, the application program may be stored in the memory 130, installed in the device, and driven to perform an operation (or function) by the processor 110.

The memory 130 may store data supporting various functions of the device and a program for the operation of the processor, input/output data (e.g., music files, still images, moving images, etc.) may be stored, and a plurality of application programs (or applications) run on the device, data for the operation of the device, and commands can be stored. At least some of these application programs may be downloaded from an external server via wireless communication.

The memory 130 may include at least one type of storage medium among a flash memory 130 type, a hard disk type, an SSD (Solid State Disk type), an SDD (Silicon Disk Drive) type, a multimedia card micro type, a card type memory (for example, an SD or XD memory, etc.), a random access memory (RAM), a static random access memory (SRAM), a read-only memory (ROM), an electrically erasable programmable read-only memory (EEPROM), a programmable read-only memory (PROM), a magnetic memory 130, a magnetic disk, and an optical disk. In addition, the memory 130 may be a database that is separate from the device but connected by wire or wirelessly.

The memory 130 may be electrically connected to the processor 110 and may store at least one code executed in the processor 110. The memory 130 may refer to various types of storage devices. The memory 130 may store information necessary for performing operations using artificial intelligence, machine learning, and artificial neural networks.

The memory 130 may store various learning models. The learning models stored in the memory may infer result values for new input data that are not learning data, and the inferred values may be used as a basis for judgment to perform a certain operation. The learning models stored in the memory may perform learning based on label information, and various backpropagation algorithms may be applied so that the loss function has a target value to increase the accuracy of learning.

In addition, the memory 130 may have a plurality of processes for the electronic device 100.

The memory 130 may store at least one artificial intelligence model for converting motion based on style.

In the embodiment of the present disclosure, the artificial intelligence model may be applied to various models such as a content feature extraction model (first model), a style feature extraction model (second model), a style generation model (third model), a VLP (Vision-Language Pre-training) model, a large-scale language model (LLM), and an encoder model.

In the embodiment below, the content feature extraction model means the first model, the style feature extraction model means the second model, and the style generation model means the third model.

The extraction module 140 may extract a target feature from various types of received data.

In detail, the extraction module 140 may extract a style feature from style information, and the extraction module 140 may extract a content feature from content motion data, and various artificial intelligence models may be used in the extraction process.

The input module 150 is for inputting image information (or signal), audio information (or signal), data, or information input from a user, and may include at least one camera, at least one microphone, and at least one of a user input module 150. Voice data or image data collected by the input module 150 may be analyzed and processed as a user's control command.

The input module 150 is for receiving information from a user, and when information is input through the input module 150, the processor 110 may control the operation of the present device to correspond to the input information. The input module 150 may include hardware-type physical keys (e.g., buttons located on at least one of the front, rear, and side of the device, dome switches, jog wheels, jog switches, etc.) and software-type touch keys. As an example, the touch key may be formed as a virtual key, a soft key, or a visual key displayed on a touchscreen-type display module through software processing, or as a touch key placed on a part other than the touchscreen. Meanwhile, the virtual key or visual key may be displayed on the touchscreen in various forms, and may be formed as, for example, a graphic, a text, an icon, a video, or a combination thereof.

The output module 160 is for generating output related to vision, hearing, or tactile sensation, and may include at least one of a display module, an audio output module 160, a haptic module, or an optical output module 160. The display module may implement a touch screen by forming a mutual layer structure with the touch sensor or forming it as an integral part. This touch screen may function as a user input module 150 that provides an input interface between the device and the user, and at the same time, may provide an output interface between the device and the user.

The display module displays (outputs) information processed by the device. For example, the display module may display execution screen information of an application program for example, an application run by the device, or UI (User Interface) or GUI (Graphical User Interface) information according to such execution screen information.

The display may display various contents (e.g., a text, an image, a video, an icon, a symbol, etc.). For example, the display may display an image corresponding to at least one image data included in the application program. In various embodiments, when the electronic device 100 adopts a VR mode, the display may separate and display one image into two images corresponding to the user's left and right eyes. In various embodiments, the display may include a liquid crystal display (LCD), a light-emitting diode (LED) display, an organic light-emitting diode (OLED) display, a microelectromechanical systems (MEMS) display, or an electronic paper display.

The audio output module 160 may output audio data received through the communication module 120 or stored in the storage module, or may output an audio signal related to a function performed in the device. The audio output module 160 may include a receiver, a speaker, a buzzer, and the like

The rendering module 170 may render an image or video and generate an image of a style motion based on a content feature and a style feature. For example, the rendering module 170 may generate an image of a style motion by rendering an image based on a content feature while reflecting a style feature.

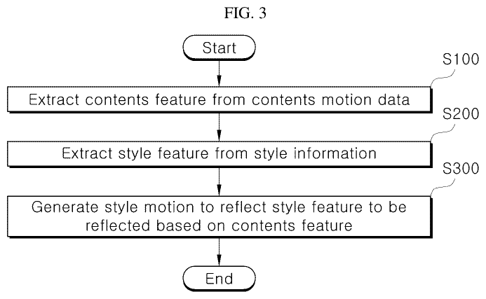

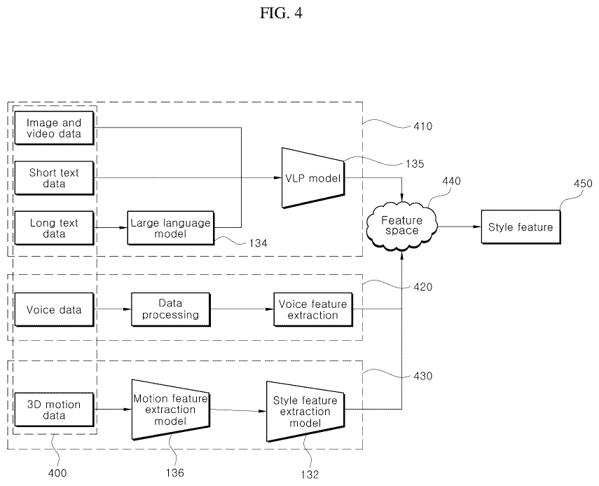

FIG. 3 is a flowchart of a motion conversion method based on style according to an embodiment of the present disclosure.

Referring to FIG. 3, the operation process of a motion conversion method based on style, method, and program according to an embodiment of the present disclosure will be described.

The processor 110 extracts a content feature from content motion data (step S100).

The content motion data is data that includes motion of an object character.

Specifically, the processor 110 may extract the content feature from the content motion data using the content feature extraction model that has learned a method of extracting the content feature.

The processor 110 extracts a style feature from style information (step S200).

The processor 110 generates a style motion so that the style feature is reflected based on the content feature (step S300).

The processor 110 may generate a style motion based on the content feature and the style feature.

In the embodiment of the present disclosure, the style information may be configured in various ways, not limited to a single format such as a text format.

Therefore, in the case that the style information is received, the processor 110 may analyze the received style information to identify the data format included in the style information, and may extract the style feature from the style information using an appropriate model based on the identified result.

In the embodiment of the present disclosure, the style information may include at least one of text data, voice data, image data, or motion data, and may further include other types of data in addition to the above-described data according to the embodiment.

According to the embodiment, the electronic device 100 may analyze a long text, such as a conversation script exchanged between characters, to identify the style of a character appearing in a movie or animation.

In addition, in the case that the processor 110 uses the voice of a character speaking in an animation or movie as input, the processor 110 may analyze the voice data to identify the character's emotion and intention, and extract the style feature.

In the case that the style information includes text data or image data, the processor 110 may analyze the data included in the style information using a VLP (Vision-Language Pre-training model) to obtain the style feature as output.

FIG. 4 is a diagram illustrating a process for extracting a style feature from style information.

Referring to FIG. 4, a process for extracting a style feature 450 according to a data format included in the style information by the electronic device 100 will be described.

The processor 110 may extract the style feature 450 from content motion data including an image, a video, and a text through a process 410 using a VLP model 135.

In one embodiment, the processor 110 may directly input style information into the VLP model 135 for data including an image, a video, and a short text data to extract the style feature 450.

In the embodiment of the present disclosure, the VLP model 135 is a model that has been pre-trained with large-scale image-text data to enable interaction between an image and a text, and is widely disclosed. Representative models include Contrastive Language-Image Pre-training (CLIP), Bootstrapping Language-Image Pre-training (BLIP), and the like. Through this, the processor 110 may extract similar feature vectors for similar content between the texts and the image.

At this time, the short text data may correspond to word-type data, which includes 1 to 2 words.

The processor 110 converts the first text data (e.g., long text data, sentence-type text data, conversational text data) that does not correspond to the short text data above into at least one second text data in the form of words expressing the character and emotion of the object included in the first text using a large language model (LLM) 134.

For example, to explain a person's life background, a tendency, and the like, there are cases where many sentences need to be input. In the case of such long text, the electronic device 100 may convert the text into a word-type text that well expresses the character and emotion included in the text using a large language model 134 such as GPT, BERT, LaMDA, and LLaMA, and use it as an input for the VLP model 135.

In addition, the processor 110 may input at least one second text data into the VLP model 135 to extract the style feature 450.

The processor 110 may extract the style feature 450 by performing the process 420 for performing data processing and extracting a voice feature when voice data is included in the style information.

At this time, the processor 110 may extract the voice feature using Mel-Frequency Cepstral Coefficients (MFCCs), Mel-spectrograms, and the like after performing data processing processes such as resampling to match the speed of voice data, filtering to obtain only data satisfying a specific criterion, and Fourier transform to decompose into a sum of periodic functions having various frequencies.

The processor 110 may perform the process 430 for extracting the style feature 450 using a motion feature extraction model 136 and the style feature extraction model 132 in the case that 3D motion data is included in the style information.

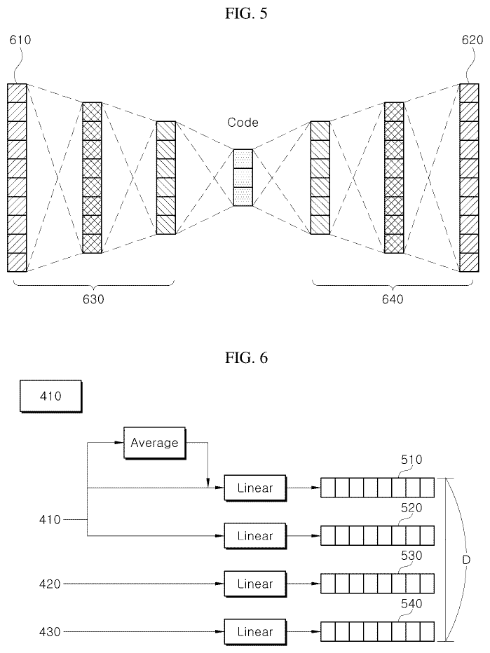

FIG. 5 is a diagram illustrating a use of an encoder model as a motion feature extraction model and a style feature extraction model of 3D motion.

FIG. 6 is a diagram illustrating a measurement of a vector distance between each extracted style feature in FIG. 4.

Referring to FIG. 5, the processor 110 may use an encoder model as the motion feature extraction model 136 and the style feature extraction model 132.

It is a neural network that trains representation learning and feature learning as in FIG. 5 in the form of unsupervised learning. Latent Vector is a latent variable, an encoder 630 corresponds to an input side 610, and a decoder 640 corresponds to an output side 620.

In this case, the encoder plays a role like a kind of a feature extractor, and the decoder plays a role of restoring the compressed data.

At this time, the style feature extracted through the process 410, 420, or 430 as in FIG. 4 exists in the form of a specific distribution for each style in the feature space 440 expressing all styles.

The processor 110 may extract the style feature 450 by sampling the style feature vector from the distribution of the corresponding style.

Referring to FIG. 6 following FIG. 4, the processor 110 inputs each result extracted through the execution of each process 410, 420, or 430 of FIG. 4 into a linear layer to calculate the vector distance value of each extracted result 510, 520, 530, or 540. At this time, the closer the calculated distance value is, the more the artificial intelligence model used in the electronic device 100 is properly trained and outputs the correct result. In other words, the electronic device 100 may train the artificial intelligence model so that the distance between the feature vector 510, 520, 530, or 540 for the style extracted through each process 410, 420, or 430 becomes closer.

At this time, the VLP model 135 is a model that has been trained in advance with large-scale image-text data to enable interaction between an image and a text, so it may process a 2D image right away, but may not process a video right away.

The reason why a Linear Layer exists at the end of each process 410, 420, or 430 is to match the size of the feature vector outputs for different input methods.

Therefore, the processor 110 may regard each frame of the video as a 2D image, pass each frame through the VLP, and use the average of the features.

The electronic device 100 will select and use one of various style input methods. Therefore, the style feature extracted through all style input methods need to be the same or almost the same.

For example, when the text “as if drunk” is input, when drunk voice data is input, and when 3D motion data including drunk motion is input, the features extracted need to be almost similar.

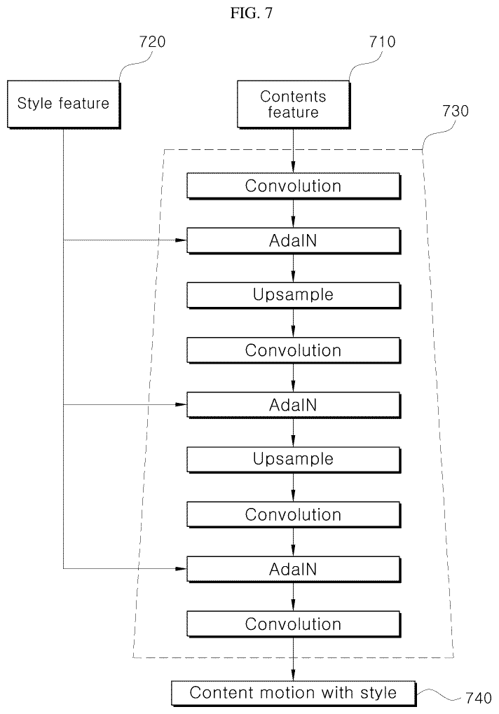

FIG. 7 is a diagram illustrating generating a content motion with style added by repeatedly performing Convolution, AdaIN, and Up-sampling.

In the embodiment of the present disclosure, the style generation model generates a style motion by combining a feature 710 of the content motion and a style feature 720.

In the embodiment of the present disclosure, the electronic device 100 may build a model using the AdaIN method to properly combine reflect the style feature 720 with the content feature 710.

AdaIN may be said to be a method of removing the style from the feature vector containing the content and then refilling the style desired by the producer.

In this case, the content feature is received through the encoder, so its size is reduced. Therefore, the processor 110 needs to perform a process of increasing the size to express the motion by performing up-sampling. As a result, the processor 110 may perform the process 730 in the form of gradually increasing the size by performing up-sampling through the model and continuously reflecting the style through AdaIN, as shown in FIG. 7.

In addition, the processor 110 may perform the process 730 as in FIG. 7 to finally generate a content motion 740 with the style feature added.

In the above-described embodiment, the AdaIN method is used as an example to reflect the style feature, but it is not limited thereto, and various algorithms and models may be applied to reflect the style feature.

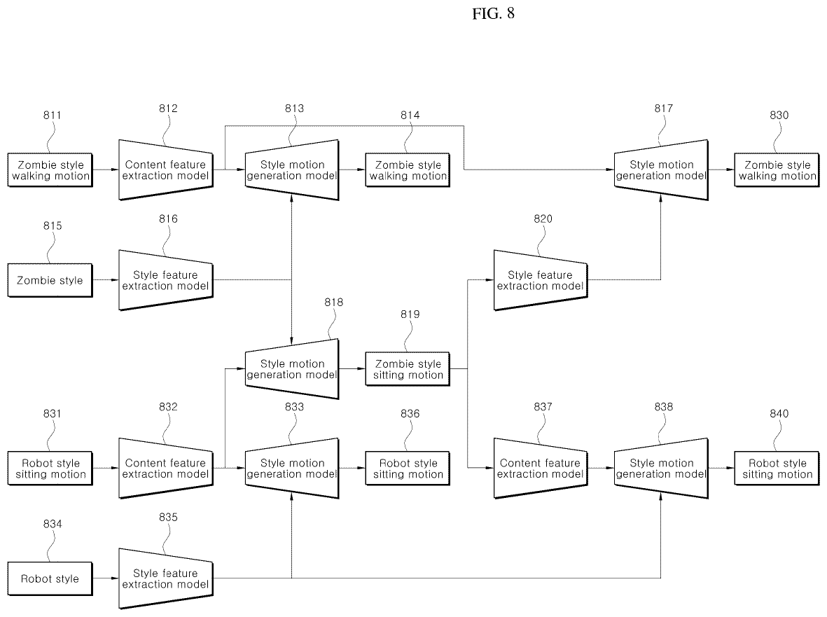

FIG. 8 is a diagram illustrating a method of learning an artificial intelligence model used in the motion conversion device based on style according to an embodiment of the present disclosure.

Referring to FIG. 8, a method of learning an artificial intelligence model by the electronic device 100 according to an embodiment of the present disclosure will be described in more detail.

The electronic device 100 may use the following learning method.

First, the processor 110 builds an input pair expressing the same style.

For example, the input pair is a text data of “as if drunk” and data including a motion of walking while drunk. The processor 110 inputs the input pair to each model and extracts each feature vector.

Then, the processor 110 inputs a loss function between two feature vectors and backpropagates it to the model. The processor 110 performs learning in this manner to make the distance between two feature vectors indicating the same style very close. As a result, the artificial intelligence model learned in this manner outputs almost similar results for feature vectors expressing the same style regardless of the input method.

In this case, the first object is a zombie style, the second object is a robot style, the first motion is a walking motion, and the second motion is a sitting motion.

The processor 110 extracts the first content feature from first content data 811 including the first motion of the first object using a content feature extraction model 812.

The processor 110 extracts the first style feature from first style information 815 of the first object using a style feature extraction model 816.

The processor 110 may generate a first style motion 814 based on the first content feature and the first style feature using a style motion generation model 813.

For example, the processor 110 inputs the first content feature and the first style feature into the style motion generation model 813 to generate the first style motion 814 in which the first style feature is reflected based on the first content feature.

In the case that the artificial intelligence model is fully learned, the distance between the vector values of the first content motion data 811 and the first style motion 814 need to be almost the same.

In one embodiment, the processor 110 trains the model so that the distance between the vector values of the first content motion data 811 and the first style motion 814 is reduced.

The processor 110 extracts the second content feature from second content motion data 831 including the second motion of the second object using a content feature extraction model 832.

The processor 110 extracts the second style feature from second style information 834 of the second object using a style feature extraction model 835.

Then, the processor 110 inputs the second content feature and the second style feature into a style motion generation model 833 to generate a second style motion 836 in which the second style feature is reflected based on the second content feature.

In the case that the artificial intelligence model is fully learned, the second content motion data 831 and the second style motion 836 need to be almost the same.

In one embodiment, the processor 110 trains the model so that the distance between the vector values of the second content motion data 831 and the second style motion 836 is reduced.

The processor 110 may generate a third style motion 819 based on the first content feature and the second style feature by using a style motion generation model 818.

For example, the processor 110 generates the third style motion 819 so that the first style feature is reflected based on the second content feature by using the style motion generation model 818.

The processor 110 extracts the third style feature from the third style motion 819 using a style feature extraction model 820.

The processor 110 generates a fourth style motion 830 so that the third style feature is reflected based on the first content feature using the style motion generation model 817.

In the case that the artificial intelligence model is completely learned, the first content motion data 811 and the fourth style motion 830 need to be almost the same.

In one embodiment, the processor 110 trains the model so that the distance between the vector values of the first content motion data 811 and the fourth style motion 830 is reduced.

The processor 110 extracts the third content feature from the third style motion 819 using a content feature extraction model 837.

The processor 110 generates a fifth style motion 840 based on the third content feature using a style motion generation model 838 so that the second style feature is reflected.

In the case that the artificial intelligence model is completely learned, the second content motion data 831 and the fifth style motion 840 need to be almost same.

In one embodiment, the processor 110 trains the model so that the distance between the vector values of the second content motion data 831 and the fifth style motion 840 is reduced.

In FIG. 8, the content feature extraction models 812, 832, and 837 may all be the same model.

In FIG. 8, the style feature extraction models 816, 835, and 820 may all be the same model.

In FIG. 8, the style motion generation models 813, 817, 818, 833, and 838 may all be the same model.

In the embodiment of the present disclosure, the processor 110 trains at least one model so that the vector value and the distance of the vector are reduced as described above, and at this time, any model that is a model required for the electronic device 100 to perform a style-based motion conversion process may be a model that is a learning target. For example, the processor 110 may train at least one model among the content feature extraction model, the style feature extraction model, the style generation model, the large-scale language model, the motion feature extraction model, and the VLP model.

The method according to one embodiment of the present disclosure described above may be implemented as a program or application and stored in a medium so as to be executed in combination with a hardware server.

The above-described program may include codes coded in a computer language, such as C, C++, JAVA, or machine language, that may be read by the processor CPU of the computer through the device interface of the computer, so that the computer reads the program and executes the methods implemented as the program. Such codes may include functional codes related to functions that define necessary functions for executing the methods, and may include control codes related to execution procedures necessary for the processor of the computer to execute the functions according to a predetermined procedure. In addition, the code may further include a memory reference-related code regarding which location address of the internal or external memory of the computer should be referenced for additional information or media required for the processor of the computer to execute the functions. In addition, in the case that the processor of the computer needs to communicate with any other computer or server located remotely to execute the functions, the code may further include a communication-related code regarding how to communicate with any other computer or server located remotely using the communication module of the computer, what information or media needs to be sent and received during the communication, and the like.

The medium in which the storage is performed means a medium that semi-permanently stores data and may be read by a device, rather than a medium that stores data for a short period of time, such as a register, cache, or memory. Specifically, examples of the medium in which the storage is performed include, but are not limited to, ROM, RAM, CD-ROM, magnetic tape, floppy disk, or optical data storage device. That is, the program may be stored in various recording media on various servers that the computer may access or in various recording media on the user's computer. In addition, the media may be distributed to computer systems connected to a network, so that computer-readable codes may be stored in a distributed manner.

The steps of the method or algorithm described in connection with the embodiments of the present disclosure may be implemented directly in hardware, implemented as a software module executed by hardware, or implemented by a combination of these. The software module may reside in random access memory (RAM), read only memory (ROM), erasable programmable ROM (EPROM), electrically erasable programmable ROM (EEPROM), flash memory, a hard disk, a removable disk, a CD-ROM, or any form of computer-readable recording medium well known in the art to which the present disclosure belongs.

Although the embodiments of the present disclosure have been described above with reference to the attached drawings, those skilled in the art will appreciate that the present disclosure may be implemented in other specific forms without changing the technical idea or essential features thereof. Therefore, it should be understood that the embodiments described above are illustrative in all respects and not restrictive.

According to the present disclosure, an effect of providing the motion conversion device based on style is provided.

In addition, according to the present disclosure, an effect of extracting the content feature from the content motion and the style feature from the style information, and then generating the style motion based on the content feature but reflecting the style feature is provided.

In addition, according to the present disclosure, an effect of extracting the style feature using a large-scale language model and a VLP model is provided.

The effects of the present disclosure are not limited to the effects mentioned above, and other effects not mentioned will be clearly understood by those skilled in the art from the description

What is claimed is:

1. An electronic device, comprising:
a memory configured to store at least one process for generating style motion; and
a processor configured to perform an operation related to the at least one process,
wherein the processor is configured to:
extract a content feature from content motion data including a motion of an object using a first model for extracting the content feature,
extract a style feature from style information using a second model for extracting the style feature, and
generate a style motion reflecting the content feature and the style feature using a third model for generating a style, wherein the style information includes at least one of a text, a voice, an image, or a motion, and
obtain the style feature from the text and the image included in the style information using a VLP (Vision-Language Pre-training) model.

2. The device according to claim 1, wherein the processor is configured to:
convert a first text of a predetermined length or longer in the text into at least one second text in the form of word expressing character and emotion of the object included in the first text using a large-scale language model (LLM), and
input the at least one second text into the VLP model, and obtain the style feature as an output value of the VLP model.

3. The device according to claim 1, wherein the processor is configured to:
based on the style information being for a character in a game, input data including a background description of the character together with the VLP model.

4. The device according to claim 1, wherein the processor is configured to:
obtain a style distribution for a feature space based on a text included in the style information using the VLP model, and
obtain the style feature by sampling a style vector from the obtained style distribution.

5. The device according to claim 1, wherein the processor is configured to:
input a first style feature obtained from the text and the image included in the style information, a second style feature obtained from the voice included in the style information, and a third style feature obtained from the motion included in the style information into a linear layer, respectively, and control vector sizes of the first style feature, the second style feature, and the third style feature to be the same, and
train the second model by reducing vector distances of the first style feature, the second style feature, and the third style feature.

6. The device according to claim 1, wherein the processor is configured to:
extract a first content feature from first content motion data including a first motion of a first object,
extract a second content feature from second content motion data including a second motion of a second object,
extract a first style feature from first style information of the first object,
extract a second style feature from second style information of the second object,
generate a first style motion based on the first content feature and the first style feature,
generate a second style motion based on the second content feature and the second style feature,
train the first model and the third model by reducing a vector distance between the first content motion data and the first style motion, and
train the first model and the third model by reducing a vector distance between the second content motion data and the second style motion.

7. The device according to claim 6, wherein the processor is configured to:
generate a third style motion based on the second content feature and the first style feature,
extract a third style feature from the third style motion,
extract a third content feature from the third style motion,
generate a fourth style motion based on the first content feature and the third style feature,
generate a fifth style motion based on the third content feature and the second style feature,
train the first model and the third model by reducing a vector distance between the first content motion data and the fourth style motion, and
train the first model and the third model by reducing a vector distance between the second content motion data and the fifth style motion.

8. The device according to claim 1, wherein the processor is configured to:
use an encoder model when extracting the content feature,
generate the style motion so that the extracted style feature is applied while removing a remaining style in the content feature using AdaIN technology, and
perform at least one up-sampling on the extracted content feature reduced in size by using the encoder model, and apply the extracted style feature.

9. A motion generation method based on style performed by a processor of an electronic device, comprising:
extracting a content feature from content motion data including a motion of an object using a first model for extracting the content feature,
extracting a style feature from style information using a second model for extracting the style feature,
generating a style motion reflecting the content feature and the style feature using a third model for generating a style, wherein the style information includes at least one of a text, a voice, an image, or a motion, and
obtaining the style feature from the text and the image included in the style information using a VLP (Vision-Language Pre-training) model.

10. A computer-readable recording medium storing a computer program for performing the motion generation method based on style of claim 9, combined with a computer device as hardware.
